(19) United States
(12) Patent Application Publication
(10) Pub. No.: US 2020/0358162 A1
(43) Pub. Date: Nov. 12, 2020

(54) PRODUCTION PROCESS FOR SLOTTING OUTER CONDUCTOR OF LEAKY CABLE

(71) Applicant: Jiangsu Hengxin Technology Co., Ltd, Yixing City (CN)

(72) Inventors: ZhiXing Yang, Yixing City (CN); WenLiang Cheng, Yixing City (CN); ShengHao Shi, Yixing City (CN); Guang Wu, Yixing City (CN); Lei Yang, Yixing City (CN); Chao Sun, Yixing City (CN)

(21) Appl. No.: 16/474,864

(22) PCT Filed: Aug. 27, 2018
(86) PCT No.: PCT/CN2018/102435

§ 371 Date: Jun. 28, 2019

(30) Foreign Application Priority Data
Aug. 7, 2018 (CN) 201810890826.8

(51) Int. Cl. H01P 11/00; H01Q 13/20; H01B 13/34; H01B 13/24

(52) U.S. Cl. CPC H01P 11/003; H01B 13/24; H01B 13/348; H01Q 13/203

(57) ABSTRACT

Disclosed is a production process for slotting an outer conductor of a leaky cable, through which an integrated production line incorporating a metal strap slotting production line, a metal strap longitudinal coating production line and a sheathing production line is provided. A semi-finished product from a leaky cable insulation process is subsequently processed by laser in a numerical control laser cutting device for cutting out corresponding slot holes in a metal strap to produce a slotted outer conductor. Then the slotted metal strap is embossed, and directly coated on an insulator in a longitudinal coating forming mould of the outer conductor. The final sheathing process is completed in a sheath plastic extruding machine to produce a finished leaky cable product. The processes of the outer conductor of the leaky cable, including the raw material punching, the longitudinal coating forming, and the outer sheathing, are finished at one time.

### CROSS REFERENCE TO RELATED APPLICATIONS

This application is a national stage application under 35 U.S.C. 371 of PCT Application No. PCT/CN2018/102435, filed on 27 Aug. 2018, which PCT application claimed the benefit of Chinese Patent Application No. 2018108908268, filed on 7 Aug. 2018, the entire disclosure of each of which are hereby incorporated herein by reference.

### FIELD

The present disclosure relates to the field of leaky cable production technologies, and more particularly, to a production process for slotting an outer conductor of a leaky cable.

### BACKGROUND

A leaky coaxial cable is a special radio frequency coaxial cable, characterized in a series of slot holes arranged in an outer conductor of the leaky coaxial cable that plays a role of shielding, so that electromagnetic energy transmitted inside the leaky coaxial cable can leak out and radiate through the slot holes, and electromagnetic energy in an external environment of the leaky coaxial cable can be inwardly coupled and absorbed through the slot holes to allow signal interaction between the leaky coaxial cable and the external environment, satisfying the requirements of mobile communication along a cable (along a laying direction of the leaky coaxial cable) on electromagnetic signals.

According to the radiation characteristics, the leaky coaxial cables may be divided into two categories: coupling leaky cables and radiating leaky cables, wherein slot holes arranged in an outer conductor of a radiating leaky cable are made of a thin copper strap punched by a punching press, and the production process described in the present disclosure is mainly suitable for the radiating leaky cable. The production of the radiating leaky cable needs to go through four processes corresponding to an inner conductor, an insulator, an outer conductor and a sheath. The outer conductor process further needs to go through two processes of thin copper strap punching and thin copper strap longitudinal coating. In the thin copper strap punching process generally carried out separately, the thin copper strap is punched by the punching press, a designated punching mould needs to be designed according to specific slot holes, and the rolled and slotted thin copper strap is outputted. The raw material used in the thin copper strap longitudinal coating process is the slotted thin copper strap, which is the thin copper strap punched with the specific slot holes by the punching press. Specifically, it is a separate process that the slotted thin copper strap is longitudinally coated on the insulator of the leaky cable. However, since the output performance is not affected by the sheath process, in order to shorten production period and improve product qualification rate, it is generally carried out at the same time with the sheath process, i.e., directly beginning the sheath process once the longitudinal coating is finished, and the production of the leaky cable and the sheath process are finished at the same time. However, due to two sequential processes in the production process of the outer conductor, i.e., the thin copper strap punching and then the thin copper strap longitudinal coating, the outer conductor is generally produced separately, which will lead to that:

1. the raw material is operated in different processes in each workshop, which takes up too much time and space for storage and is easy to be polluted by the environment, thus affecting the use quality, and meanwhile, the separate thin copper strap punching process in the outer conductor process needs to reserve an operation area and a device area, thus occupying a large space;

2. the separate thin copper strap punching process in the outer conductor process needs to match with a finished product process in product quantity, resulting in that the production quantity of the outer conductor needs to be more than the quantity of next process, and excessive production results in more waste of materials in the final process;

3. the slotted thin copper strap for the outer conductor is produced by the punching press with large precision fluctuation due to device and process problems;

4. the slotted thin copper strap for the outer conductor is produced by the punching press with a punching mould, for which one punching mould can only be suitable for one slotted structure, resulting in high cost of the mould; and when the slotted structure is varied, the mould needs to be replaced, so flexible production is not possible, and multiple groups of slotted structures cannot be arranged in one continuous leaky cable; and

5. the slotted thin copper strap for the outer conductor is produced by the punching press, which needs to open the mould in advance according to different slot types, therefore in order to ensure the punching quality and service life of the mould, the processing of the mould is complicated and the time for opening the mould is long.

### SUMMARY

With respect to the problems above, the present disclosure provides a production process for slotting an outer conductor of a leaky cable, which integrates a metal strap slotting production line, a metal strap longitudinal coating production line and a sheathing process production line into an integrated production line, thus saving the operation and storage of raw materials, avoiding waste or pollution caused in the operation and storage processes, and improving the implement efficient and reliable production.

In the disclosure, the production process for slotting an outer conductor of a leaky cable includes cutting out corresponding slot holes in a metal strap by laser by means of a numerical control laser cutting device according to specific slotting parameters to produce a slotted outer conductor, after a semi-finished product is completed from a leaky cable insulation process; embossing, and directly coating the slotted metal strap on an isolator by means of a longitudinal coating forming mould for the outer conductor; and conducting a sheathing process directly by a sheath plastic extruding machine to produce a finished leaky cable product. So that the three processes of the outer conductor of the leaky cable, including the raw material punching, the longitudinal coating forming and the outer sheathing of the outer conductor after being formed, are finished at one time.

Further, the metal strap includes, but not limited to, a copper strap, an aluminum strap or a silver strap.

Further, the slotting parameters are not limited to length, thickness, production time and slotting pattern of the raw materials. The slotting parameters are set according to slot parameters required by the leaky cable before production.

Further, the slotting pattern includes a fixed slot group and a gradually varied slot group along production length, the gradually varied parameters of the gradually varied slot group include a slot type, a slot length, a slot width, a slot tilt angle, a slot group spacing and a slot spacing.

Further, the production process is suitable for a slot group structure gradually varied with a production length.

Further, the production process is suitable for producing a fixed slot group structure at the same time.

Further, the numerical control laser cutting device is a solid laser processing device, and adopts a non-contact processing mode of laser thermal processing to process the slot holes in the outer conductor of the leaky cable.

Further, the metal strap after laser processing is directly embossed by an embossing machine, and then coated on an insulating outer surface by the longitudinal coating forming mould of the outer conductor, and finally, the sheath production is finished by the sheath plastic extruding machine to output the finished leaky cable product.

By adopting the process according to the present disclosure, after the semi-finished product outputted by the leaky cable insulation process is produced, the numerical control laser cutting device is used to cut out corresponding slot holes in the metal strap by laser according to specific slotting parameters to produce the slotted outer conductor. Subsequently the slotted metal strap is embossed and directly coated on the insulator by the longitudinal coating forming mould of the outer conductor, and finally the sheath production is directly finished by the sheath plastic extruding machine to produce the finished leaky cable product. So that the three processes of the outer conductor of the leaky cable, including the raw material punching, the longitudinal coating forming and the outer sheathing of the outer conductor after being formed, are finished at one time. The production process integrates the metal strap slotting production line with, the metal strap longitudinal coating production line and the sheathing process production line into the integrated production line, thus saving the operation and storage of raw materials, avoiding waste or pollution caused in the operation and storage processes, and allowing the production is efficient and reliable.

### DETAILED DESCRIPTION

A production process for slotting an outer conductor of a leaky cable according to the disclosure includes the follows steps that: after a semi-finished product outputted from a leaky cable insulation process is completed, according to specific slotting parameters, corresponding slot holes are cut out in a thin copper strap by means of a numerical control laser cutting device by laser, such that a slotted outer conductor is produced; then the slotted thin copper strap is directly coated on an isolator by a longitudinal coating forming mould of the outer conductor; and finally the sheath production is directly finished by a sheath plastic extruding machine to produce a finished leaky cable product. So that three processes of the outer conductor of the leaky cable, including the raw material punching, the longitudinal coating forming and the outer sheathing of the outer conductor after being formed, are finished at one time.

The metal strap includes, but not limited to, a copper strap, an aluminum strap or a silver strap.

The slotting parameters are not limited to length, thickness, production time and slotting pattern of the raw materials, and the slotting parameters are set before production according to slot parameters required by the leaky cable.

The slotting pattern includes a fixed slot group and a gradually varied slot group along production length, the gradually varied parameters of the gradually varied slot group include a slot type, a slot length, a slot width, a slot tilt angle, a slot group spacing and a slot spacing.

The numerical control laser cutting device is a solid laser processing device which has a non-contact processing mode of laser thermal processing to process the slot holes in the outer conductor of the leaky cable.

The thin copper strap after laser processing is directly embossed by an embossing machine, and then coated on an insulating outer surface by the longitudinal coating forming mould of the outer conductor. The sheath production is finally finished by the sheath plastic extruding machine to output the finished leaky cable product.

By adopting the process according to the present disclosure, after the semi-finished product outputted by the leaky cable insulation process is produced, the numerical control laser cutting device is used to cut out corresponding slot holes in the metal strap by laser according to specific slotting parameters to produce the slotted outer conductor. Subsequently the slotted thin copper strap is directly coated on the insulator by the longitudinal coating forming mould of the outer conductor, and finally the sheath production is directly finished by the sheath plastic extruding machine to produce the finished leaky cable product. So that the three processes of the outer conductor of the leaky cable, including the raw material punching, the longitudinal coating forming and the outer sheathing of the outer conductor after being formed, are finished at one time. The production process integrates the metal strap slotting production line with, the metal strap longitudinal coating production line and the sheathing process production line into the integrated production line, thus saving the operation and storage of raw materials, avoiding waste or pollution caused in the operation and storage processes, and allowing the production to be efficient and reliable.

Two sub-processes of metal strap slotting and the metal strap longitudinal coating in an outer conductor process are combined with a sheathing process production line, in which a metal strap processing device used is a solid laser processing device having laser thermal processing mode. The direct laser processing tool belongs to non-contact processing tool without a mould. Therefore, mould cost, mould processing period and mould abrasion are not generated, friction resistance is not generated with a surface of a workpiece, and noise is not generated either. Meanwhile, since the energy, the relatively moving speed and the position of the laser beam can be controlled and adjusted by a numerical control machine tool, the laser processing is no longer limited to a processing object like the traditional punching. The application level and range of the laser processing are greatly improved, and the thickness of the processed thin copper strap and the selection of available metal types (such as aluminum strap) are more comprehensive. The metal strap after laser processing is directly embossed by an embossing machine and then coated on an insulating outer surface by the longitudinal coating forming mould of the outer conductor, and the sheath production is finally finished by the sheath plastic extruding machine to output the finished leaky cable product.

The production process may be applied to a slot group structure gradually varied with a production length and production of a fixed slot group structure; the production process finishes the three processes integrally, thus saving the operation and storage of raw materials and avoiding waste or pollution caused in the operation and storage processes. Meanwhile, since the laser processing device has a small volume and may be integrated at a front end of a sheath process, an occupied area of the device and an occupied area for storage and operation of the semi-finished product can be effectively saved. Due to sequential and synchronous conduction, waste caused by extra production of the metal strap of the outer conductor to match the quantity of finished leaky cable products is avoided. The lase processing device used has high precision, with the precision reaching up to 0.01 mm, and a small difference between the slotting parameters and the plan parameters, so that the production processing is more reliable. The laser processing device uses laser for metal processing without needing the mould, thus saving time and cost on mould processing, and saving mounting and replacement works of the mould. The laser processing device has a high level of intelligence, may be produced according to a CAD drawing, which is more flexible in production and processing. Since one process is reduced, the production efficiency is improved.

When the process according to the present disclosure is used in the production of the gradually varied slotting leaky cable, the slot group gradually varied with a production length can be produced according to the design, and any factors of the slotting parameters such as a slot type, a slot length, a slot width, a slot tilt angle, a slot group spacing (also called a slot pitch and a slot period) and a slot spacing may be varied.

Taken as a whole, the technical solution of the disclosure is of great significance in improving the production efficiency for leaky cable, compared to conventional production processes. With the production process of the disclosure, costs of production time, resource cost and space cost, and solve the problem that the outer conductor of the leaky cable with gradually varied performance (the leaky cable requiring multiple sets of slotting parameters on one leaky cable) is difficult to be processed.

It is to be noted that, the forgoing embodiments are merely used for describing the technical solutions of the present disclosure, rather than limiting the present disclosure. A person of ordinary skill in the art should understand that it is also possible to make modifications to the specific implementations of the present invention or equivalent replacements to a part of the technical features, and these modifications or equivalent replacements shall fall into the scope of the technical solutions sought to be protected by the present invention.

1. A production process for slotting an outer conductor of a leaky cable, comprising:
cutting out corresponding slot holes in a metal strap by laser by means of a numerical control laser cutting device according to specific slotting parameters to produce a slotted outer conductor, after a semi-finished product is completed from a leaky cable insulation process;
embossing, and directly coating the slotted metal strap on an isolator by means of a longitudinal coating forming mould for the outer conductor; and
conducting a sheathing process directly by a sheath plastic extruding machine to produce a finished leaky cable product;
such that, the three processes of the outer conductor of the leaky cable from the raw material punching, the longitudinal coating forming and the outer sheathing of the outer conductor after being formed are finished at one time.

2. The production process according to claim 1, wherein the metal strap comprises, a copper strap, an aluminum strap or a silver strap.

3. The production process according to claim 1, wherein the slotting parameters comprises, length, thickness, production time and slotting pattern of the raw materials, which are set according to slot parameters required by the leaky cable.

4. The production process according to claim 1, wherein the slotting pattern comprises a fixed slot group and a slot group gradually varied with a production length, and gradually varied parameters of the gradually varied slot group comprise a slot type, a slot length, a slot width, a slot tilt angle, a slot group spacing and a slot spacing.

5. The production process according to claim 1, wherein the production process is suitable for producing a slot group structure gradually varied with a production length.

6. The production process according to claim 1, wherein the production process is suitable for producing a fixed slot group structure.

7. The production process according to claim 1, wherein the numerical control laser cutting device is a solid laser processing device which processes the slot holes in the outer conductor of the leaky cable by means of a non-contact thermal processing mode of laser.

8. The production process according to claim 1, wherein: after laser processing, the metal strap is directly embossed by means of an embossing machine, and then coated on an insulating outer surface by means of the longitudinal coating forming mould for the outer conductor; and the sheathing process is finally conducted by a sheath plastic extruding machine to output the finished leaky cable product.
